(19) United States
(12) Patent Application Publication
(10) Pub. No.: US 2004/0181907 A1
(43) Pub. Date: Sep. 23, 2004

(54) Ball-shaped caster assembly

(76) Inventor: Wan-Chen Lee, Taichung (TW)

Correspondence Address: Wan-Chen Lee, 58, Ma Yuan West St., Taichung, TW

(21) Appl. No.: 10/392,200

(22) Filed: Mar. 17, 2003

(51) Int. Cl. E05D 7/06

(52) U.S. Cl. 16/240

(57) ABSTRACT

A ball-shaped caster assembly includes a wheel seat, and a wheel body rotatably mounted on the wheel seat. The wheel body includes a roller having two opposite sides, and two covers each mounted on a respective one of the two opposite sides of the roller. The roller and each of the two covers have an outer surface formed with a thin shell wall. Thus, the wheel body will not be deformed and can maintain its circularity during fabrication, so that the wheel body can be rolled smoothly and conveniently without incurring jump.

### BACKGROUND OF THE INVENTION

1. Field of the Invention

The present invention relates to a ball-shaped caster assembly, and more particularly to a ball-shaped caster assembly, wherein the wheel body will not be deformed and can maintain its circularity during fabrication, so that the wheel body can be rolled smoothly and conveniently without incurring jump.

2. Description of the Related Art

A conventional caster in accordance with the prior art shown in FIG. 1 comprises a wheel seat 1 having an upper portion provided with a support shaft 11 and a lower portion formed with two ears 12 each formed with a concave portion 14 and a through hole 13, a wheel body 3 rotatably mounted on the wheel seat 1 under the arcuate edge 15 of the wheel seat 1 and formed with a shaft hole 31, a shaft 4 extended through the through hole 13 of each of the two ears 12 of the wheel seat 1, and through the shaft hole 31 of the wheel body 3, so that the wheel body 3 is rotatably mounted on the wheel seat 1, and two end caps 2 each inserted into the concave portion 14 of the wheel seat 1.

However, the conventional caster in accordance with the prior art has the following disadvantages.

1. The wheel body 3 is solid and is made by the plastic injection molding process. Thus, after the wheel body 3 is cooled after the injection molding process, the surface will produce depressions or cracks due to the expansion and shrinkage effect, so that the wheel body 3 will be deformed during fabrication and cannot maintain its circularity. Thus, the wheel body 3 cannot be rolled smoothly and conveniently.

2. The wheel body 3 bears the pressure of the weight load, so that it needs to be made of material having a greater strength and stiffness, thereby increasing costs of fabrication.

3. The wheel body 3 only has a single color and lacks variation, thereby decreasing the aesthetic quality of the caster.

### SUMMARY OF THE INVENTION

The present invention is to mitigate and/or obviate the disadvantage of the conventional caster.

The primary objective of the present invention is to provide a ball-shaped caster assembly, wherein the wheel body will not be deformed and can maintain its circularity during fabrication, so that the wheel body can be rolled smoothly and conveniently without incurring jump.

Another objective of the present invention is to provide a ball-shaped caster assembly, wherein the roller adopts material having a greater strength, while each of the two covers adopts material having a smaller strength, thereby decreasing costs of fabrication.

A further objective of the present invention is to provide a ball-shaped caster assembly, wherein the roller and each of the two covers can have different colors, thereby enhancing the aesthetic quality of the ball-shaped caster assembly.

In accordance with the present invention, there is provided a ball-shaped caster assembly, comprising a wheel seat, a wheel body rotatably mounted on the wheel seat, and a shaft extended through the wheel seat and the wheel body for mounting the wheel body on the wheel seat, wherein:

the wheel body includes a roller having two opposite sides, and two covers each mounted on a respective one of the two opposite sides of the roller;

the roller has an outer surface formed with a thin shell wall; and

each of the two covers has an outer surface formed with a thin shell wall.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a conventional caster in accordance with the prior art;

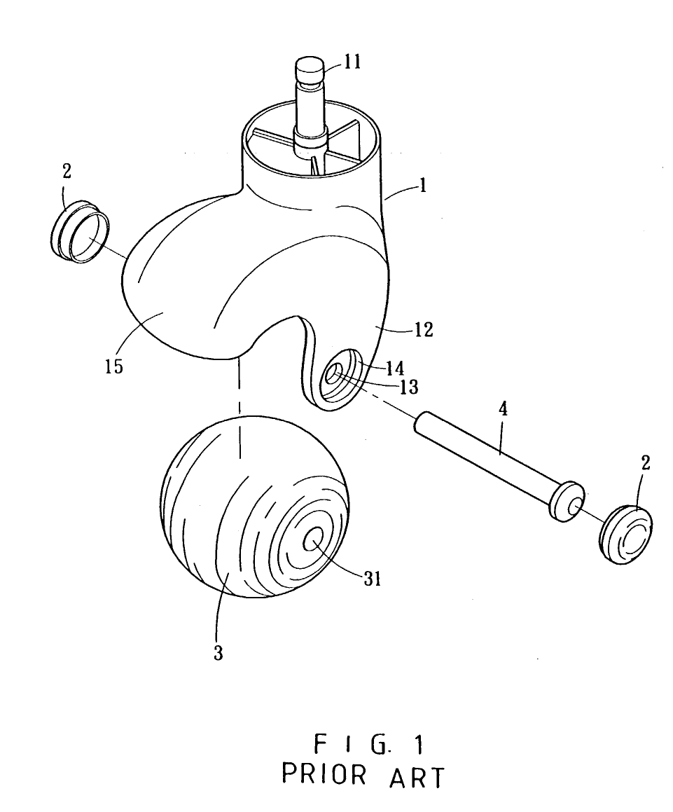

FIG. 2 is an exploded perspective view of a ball-shaped caster assembly in accordance with the preferred embodiment of the present invention; and

FIG. 3 is a perspective assembly view of the ball-shaped caster assembly in accordance with the preferred embodiment of the present invention.

### DETAILED DESCRIPTION OF THE INVENTION

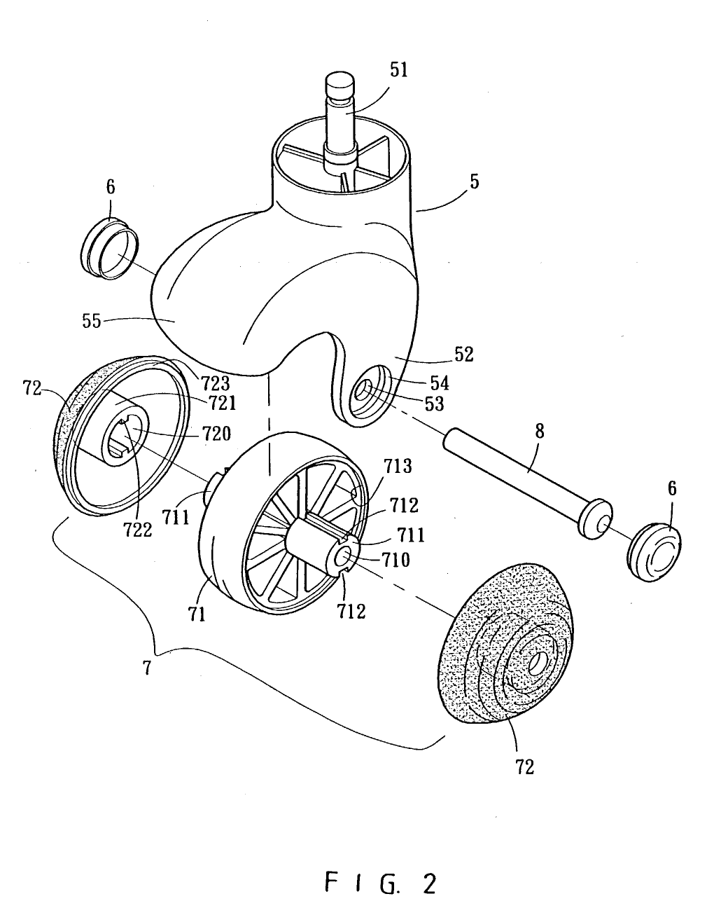

Referring to the drawings and initially to FIG. 2, a ball-shaped caster assembly in accordance with the preferred embodiment of the present invention comprises a wheel seat 5, a wheel body 7, and a shaft 8.

The wheel seat 5 has an upper portion provided with a support shaft 51, and a lower portion formed with two spaced ears 52 each formed with a concave portion 54 and a through hole 53. The lower portion of the wheel seat 5 is formed with an arcuate edge 55.

The wheel body 7 is rotatably mounted on the wheel seat 5 and located under the arcuate edge 55 of the wheel seat 5. Preferably, the wheel body 7 has a substantially spherical shape.

The wheel body 7 includes a roller 71 having two opposite sides, and two covers 72 each mounted on a respective one of the two opposite sides of the roller 71. Thus, the roller 71 is combined with the two covers 72 to form the wheel body 7 having a substantially spherical shape.

The roller 71 has an outer surface formed with a spherical thin shell wall.

Each of the two opposite sides of the roller 71 has a center formed with an insertion portion 711.

The insertion portion 711 of the roller 71 has a center formed with a shaft hole 710 and a periphery formed with two radially opposite insertion slots 712.

Each of the two opposite sides of the roller 71 has a periphery formed with an annular insertion groove 713.

Each of the two covers 72 also has an outer surface formed with a spherical thin shell wall.

Each of the two covers 72 has a center formed with a mounting portion 721 mounted on the insertion portion 711 of the roller 71.

The mounting portion 721 of each of the two covers 72 has an inner wall formed with an insertion hole 720 for insertion of the insertion portion 711 of the roller 71.

The inner wall of the mounting portion 721 of each of the two covers 72 is formed with two radially opposite insertion ribs 722 each inserted into a respective one of the two radially opposite insertion slots 712 of the insertion portion 711 of the roller 71.

Each of the two covers 72 has a periphery formed with an annular insertion flange 723 inserted into the insertion groove 713 of the roller 71.

The shaft 8 is extended through the wheel seat 5 and the wheel body 7, so that the wheel body 7 is rotatably mounted on the wheel seat 5. Preferably, the shaft 8 is extended through the through hole 53 of each of the two spaced ears 52 of the wheel seat 5, each of the two covers 72, and through the shaft hole 710 of the roller 71, so that the wheel body 7 is rotatably mounted on the wheel seat 5.

The ball-shaped caster assembly further comprises two end caps 6 each inserted into the concave portion 54 of a respective one of the two spaced ears 52 of the wheel seat 5.

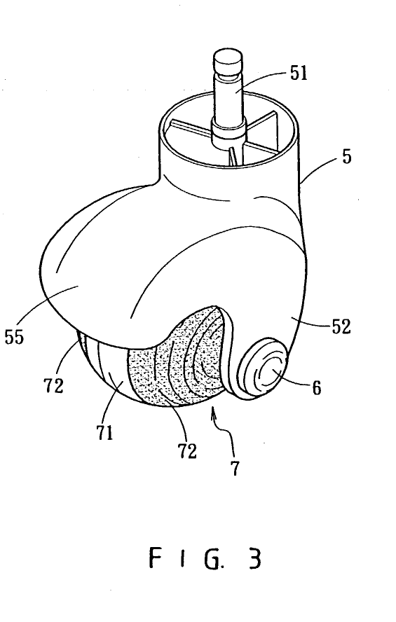

In assembly, the insertion portion 711 of the roller 71 is inserted into the insertion hole 720 of the mounting portion 721 of each of the two covers 72, with each of the two radially opposite insertion ribs 722 of the mounting portion 721 of each of the two covers 72 being inserted into a respective one of the two radially opposite insertion slots 712 of the insertion portion 71 1 of the roller 71, and with the insertion flange 723 of each of the two covers 72 being inserted into the insertion groove 713 of the roller 71, so that each of the two covers 72 is combined with the roller 71 rigidly and stably, thereby forming the spherical wheel body 7. Then, the spherical wheel body 7 is mounted on the wheel seat 5. Then, the shaft 8 is extended through the through hole 53 of each of the two spaced ears 52 of the wheel seat 5, each of the two covers 72, and through the shaft hole 710 of the roller 71, so that the wheel body 7 is rotatably mounted on the wheel seat 5, thereby forming the ball-shaped caster assembly as shown in FIG. 3.

Referring to FIGS. 2 and 3, the roller 71 has an outer surface formed with a spherical thin shell wall, and each of the two covers 72 also has an outer surface formed with a spherical thin shell wall. In such a manner, when the roller 71 and each of the two covers 72 are cooled after the injection molding process, the surface will not produce depressions or cracks due to the expansion and shrinkage effect, so that the wheel body 7 will not be deformed during fabrication. Thus, after the wheel body 7 is assembled by combining the roller 71 and each of the two covers 72, the wheel body 7 will not be deformed and can maintain its circularity, so that the wheel body 7 can be rolled smoothly and conveniently without incurring jump.

In addition, when the wheel body 7 is rolling, only the roller 71 touches the ground, so that only the roller 71 bears the pressure of the weight load. Thus, the roller 71 adopts material having a greater strength, while each of the two covers 72 adopts material having a smaller strength, thereby decreasing costs of fabrication.

Further, the roller 71 and each of the two covers 72 can have different colors, thereby enhancing the aesthetic quality of the ball-shaped caster assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A ball-shaped caster assembly, comprising a wheel seat, a wheel body rotatably mounted on the wheel seat, and a shaft extended through the wheel seat and the wheel body for mounting the wheel body on the wheel seat, wherein:
the wheel body includes a roller having two opposite sides, and two covers each mounted on a respective one of the two opposite sides of the roller;
the roller has an outer surface formed with a thin shell wall; and
each of the two covers has an outer surface formed with a thin shell wall.

2. The ball-shaped caster assembly in accordance with claim 1, wherein the thin shell wall of the roller is substantially spherical.

3. The ball-shaped caster assembly in accordance with claim 1, wherein the thin shell wall of each of the two covers is substantially spherical.

4. The ball-shaped caster assembly in accordance with claim 1, wherein the wheel body has a substantially spherical shape.

5. The ball-shaped caster assembly in accordance with claim 1, wherein the roller is combined with the two covers to form the wheel body having a substantially spherical shape.

6. The ball-shaped caster assembly in accordance with claim 1, wherein each of the two opposite sides of the roller has a center formed with an insertion portion, and each of the two covers has a center formed with a mounting portion mounted on the insertion portion of the roller.

7. The ball-shaped caster assembly in accordance with claim 6, wherein the insertion portion of the roller has a periphery formed with two radially opposite insertion slots, and the mounting portion of each of the two covers has an inner wall formed with two radially opposite insertion ribs each inserted into a respective one of the two radially opposite insertion slots of the insertion portion of the roller.

8. The ball-shaped caster assembly in accordance with claim 1, wherein each of the two opposite sides of the roller has a periphery formed with an annular insertion groove, and each of the two covers has a periphery formed with an annular insertion flange inserted into the insertion groove of the roller.

9. The ball-shaped caster assembly in accordance with claim 6, wherein the mounting portion of each of the two covers has an inner wall formed with an insertion hole for insertion of the insertion portion of the roller.

10. The ball-shaped caster assembly in accordance with claim 1, wherein the insertion portion of the roller has a center formed with a shaft hole for passage of the shaft.

11. The ball-shaped caster assembly in accordance with claim 1, wherein the roller and each of the two covers are made of different materials.

12. The ball-shaped caster assembly in accordance with claim 1, wherein the roller and each of the two covers have different colors, thereby enhancing the aesthetic quality of the ball-shaped caster assembly.
